(19) United States
(12) Patent Application Publication
(10) Pub. No.: US 2019/0099993 A1
(43) Pub. Date: Apr. 4, 2019

(54) APPARATUS AND METHOD FOR CUTTING MULTILAYER MATERIAL

(71) Applicant: INDUSTRIAL TECHNOLOGY RESEARCH INSTITUTE, Hsin-chu (TW)

(72) Inventors: Yuan-Di Chen, Tainan (TW); Wu-Jung Tsai, Tainan (TW)

(21) Appl. No.: 15/876,556

(22) Filed: Jan. 22, 2018

(30) Foreign Application Priority Data
Oct. 3, 2017 (TW) 106134241

(51) Int. Cl. B32B 43/00; B23K 26/00; B23K 26/06; B23K 26/067; B26F 1/31; G02B 27/00; G02B 27/12; G02B 27/28

(52) U.S. Cl. CPC B32B 43/003; B23K 26/0006; B23K 26/0652; B23K 26/067; B26F 1/31; B32B 2457/20; G02B 27/123; G02B 27/126; G02B 27/283; B32B 2307/412; B32B 2307/418; G02B 27/0075

(57) ABSTRACT

An apparatus for cutting a multilayer material includes a splitter module and a uniaxial crystal element. The splitter module, located in a transmission path of an incident light beam, is used for splitting the incident light beam into a first polarized light beam and a second polarized light beam. The uniaxial crystal element is disposed adjacent to the splitter module and on a transmission path of the first polarized light beam and the second polarized light beam. The first polarized light beam and the second polarized light beam pass through the uniaxial crystal element individually by having the first polarized light beam and the second polarized light in correspondence to different index of refractions, so that two focuses with different focal lengths can be obtained. In addition, a method for cutting a multilayer material method is also provided.

### CROSS REFERENCE TO RELATED APPLICATION

The present application is based on, and claims priority from, Taiwan (International) Application Serial Number 106134241, filed on Oct. 3, 2017, the disclosure of which is hereby incorporated by reference herein in its entirety.

### TECHNICAL FIELD

The present disclosure relates in general to a cutting or machining apparatus and a method thereof, and more particularly to an apparatus and method for cutting a multilayer material that can perform one-process work upon the multilayer material, especially the transparent multilayer material.

### BACKGROUND

Along with booming development of technology, a multilayer substrate with high strength and environmental resistance is one of new trends for handheld and wearable devices. However, current machining or cutting processes are seldom to meet practical requirements in cutting various multilayer substrates. Hence, it is urgent to develop a new cutting technique for these multilayer substrates, especially those made of multilayer composite materials.

For example, the single-point focused beam technique is one of existing cutting processes available for the multilayer materials. While a single-point focused beam is applied to machine a multilayer material, at least two steps of cutting are necessary. Typically, pilot cuts are firstly formed on individual tops of layers of the multilayer material, and then further layer cracking can be performed. It is obvious that such cutting work needs not only tremendous machining time, but also causes unexpected optical and precision problems. In particular, the work of forming individual pilot cuts on all respective layers of the material might lead to manufacturing difficulty in demanding precisions for optical and scanning alignments, from which a cost hike in the cutting process could be inevitable. For another example, the linear light beam cutting technique is known to be another existing process for cutting the multilayer materials. While a linear light beam (generally, a laser beam) is introduced to penetrate the multilayer material, laser energy would be accumulated at each interface (the junction between two laminated layers) and induce phenomena of penetration, reflection and refraction. Then, the accumulated laser energy would be radiated, with part thereof being absorbed by the interfaces. The laser energy kept by individual interfaces would lead to uneven cutting precisions and varying widths at the heterogeneous areas between the laminated layers.

Hence, the topic of improving the apparatus and method for cutting a multilayer material and inhibiting the aforesaid shortcomings is definitely urgent ad welcome to the art.

### SUMMARY

An object of the present disclosure is to provide an apparatus for cutting a multilayer material, that divides a bi-polarized light beam into two light beams for forming two respective focuses with different focal lengths, such that these two light beams can be applied to cut respective surfaces on two individual layers of the multilayer material, for which the corresponding refractive indexes are different. Thereupon, the aforesaid shortcoming in varying widths at the heterogeneous area of the multilayer material by the conventional cutting can thus be improved, and also cutting cracks around the cut can be reduced substantially.

Another object of this present disclosure is to provide a method for cutting a multilayer material, that forms two different stressing points to cut respective layers in the multilayer material by providing two light beams with different focal lengths from the same bi-polarized light beam; such that a crack-affected area can be diminished, and the aforesaid shortcoming in varying widths at the heterogeneous area of the multilayer material by the conventional cutting can be substantially improved.

In this disclosure, an apparatus for cutting a multilayer material includes a splitter module and a uniaxial crystal element. The splitter module, located on a transmission path of an incident light beam, is to split the incident light beam into a first polarized light beam and a second polarized light beam. The uniaxial crystal element, located close to the splitter module, has an optical axis perpendicular to a normal line of the same uniaxial crystal element. The uniaxial crystal element is located on both transmission paths of the first polarized light beam and the second polarized light beam. The first polarized light beam and the second polarized light beam pass through the uniaxial crystal element individually by having the first polarized light beam corresponding to a first refractive index and the second polarized light beam corresponding to a second refractive index different to the first refractive index. The first polarized light beam has a first focus, the second polarized light beam has a second focus, and a focal length of the first focus is different to that of the second focus.

In one embodiment of the present disclosure, the apparatus for cutting a multilayer material further includes a rotation element, the uniaxial crystal element is mounted at the rotation element, a focus difference is formed between the first focus and the second focus, the rotation element is to rotate the uniaxial crystal element so as able to adjust the focus difference, and the rotation element has a rotation axis either being located on the transmission path of the incident light beam or forming an angle with the incident light beam.

In one embodiment of the present disclosure, the focus difference is within −15 mm˜15 mm.

In one embodiment of the present disclosure, the first polarized light beam and second polarized light beam are coaxial or separated by a spacing.

In one embodiment of the present disclosure, the spacing between the first polarized light beam and second polarized light beam is adjustable.

In one embodiment of the present disclosure, the apparatus for cutting a multilayer material further includes an adjustment platform connected with the uniaxial crystal element, and the adjustment platform is to displace the uniaxial crystal element so as to adjust positions of the first focus and the second focus.

In one embodiment of the present disclosure, the uniaxial crystal element is one of a uni-axial crystal lens and a birefringent lens.

In one embodiment of the present disclosure, the uniaxial crystal element includes at least one uni-axial crystal lens, or at least one uni-axial crystal lens and a lens made of isotropic materials.

In one embodiment of the present disclosure, the splitter module includes a polarizing beam splitter located on the transmission path of the incident light beam for splitting the incident light beam into the first polarized light beam and the second polarized light beam.

In one embodiment of the present disclosure, the splitter module includes a wave plate located in front of the polarizing beam splitter for adjusting light-intensity percentages of the first polarized light beam and the second polarized light beam.

In one embodiment of the present disclosure, the wave plate is one of a half-wave plate and a quarter-wave plate.

In one embodiment of the present disclosure, the splitter module includes a first attenuation element and a second attenuation element, both located on the corresponding transmission paths of the first polarized light beam and the second polarized light beam, respectively. The first attenuation element and the second attenuation element are to adjust light-intensity percentages of the first polarized light beam and the second polarized light beam, respectively.

In one embodiment of the present disclosure, the splitter module includes a first reflection element and a second reflection element, located oppositely to each other and aside to the polarizing beam splitter. The first attenuation element is positioned between the first reflection element and the polarizing beam splitter, and the second attenuation element is positioned between the second reflection element and the polarizing beam splitter.

In one embodiment of the present disclosure, the first reflection element is movable with respect to the polarizing beam splitter.

In one embodiment of the present disclosure, the second reflection element is movable with respect to the polarizing beam splitter.

In one embodiment of the present disclosure, the splitter module includes a first wave plate and a second wave plate, located individually aside to the polarizing beam splitter.

In one embodiment of the present disclosure, each of the first wave plate and the second wave plate is one of a half-wave plate and a quarter-wave plate.

In one embodiment of the present disclosure, the apparatus for cutting a multilayer material further includes a light source for generating an initial light beam. The wave plate located on a transmission path of the initial light beam is to change a polarization of the initial light beam so as to form the incident light beam.

In one embodiment of the present disclosure, the apparatus for cutting a multilayer material further includes a control element connected with the light source and the uniaxial crystal element.

In one embodiment of the present disclosure, the apparatus for cutting a multilayer material further includes a spatial filtering element located aside to the light source and on the transmission path of the initial light beam.

In the present disclosure, the method for cutting a multilayer material includes the steps of: (1) a splitter module splitting an incident light beam into a first polarized light beam and a second polarized light beam; (2) the first polarized light beam and the second polarized light beam passing through an uniaxial crystal element individually by having the first polarized light beam corresponding to a first refractive index and the second polarized light beam corresponding to a second refractive index different to the first refractive index; so that the first polarized light beam has a first focus, and the second polarized light beam has a second focus; a focal length of the first focus being different to that of the second focus, a focus difference existing between the first focus and the second focus; and, (3) the first focus and the second focus being located individually on a surface of a first layer structure and another surface of a second layer structure of a multilayer material, respectively.

In one embodiment of the present disclosure, after the step (2), the method for cutting a multilayer material further includes an adjustment process.

In one embodiment of the present disclosure, the adjustment process includes a step of rotating the uniaxial crystal element to adjust the focus difference.

In one embodiment of the present disclosure, the adjustment process includes a step of displacing the uniaxial crystal element to adjust positions of the first focus and the second focus.

In one embodiment of the present disclosure, the adjustment process includes a step of adjusting individually light-intensity percentages of the first polarized light beam and the second polarized light beam.

In one embodiment of the present disclosure, the adjustment process includes a step of varying an optical path difference of the first polarized light beam and the second polarized light beam.

In one embodiment of the present disclosure, the aforesaid step (3) further includes the step of: (31) basing on a distance between the surface of the first layer structure and the another surface of the second layer structure of the multilayer material to obtain the focus difference; (32) basing on the focus difference to find out a rotation angle of a distribution of refractive index for the uniaxial crystal element; (33) rotating the uniaxial crystal element by the rotation angle; (34) shading orderly the second polarized light beam and the first polarized light beam; (35) adjusting a distance between the uniaxial crystal element and the multilayer material so as to find out orderly a position of the first focus of the first polarized light beam on the surface of the first layer structure of the multilayer material and another position of the second focus of the second polarized light beam on the another surface of the second layer structure of the multilayer material; (36) adjusting the rotation angle of the uniaxial crystal element to fulfill the focus difference; (37) shading the second polarized light beam; (38) locating the first focus of the first polarized light beam onto the surface of the first layer structure of the multilayer material; and, (39) emitting the first polarized light beam and the second polarized light beam to the multilayer material.

In one embodiment of the present disclosure, the step (35) includes a sub-step of applying one of a coaxial vision test and a laser line test to locate the first focus of the first polarized light beam and the second focus of the second polarized light beam onto the corresponding surfaces of the first layer structure and the second layer structure of the multilayer material.

In one embodiment of the present disclosure, the method for cutting a multilayer material further includes a step of generating the incident light beam by generating an initial light beam firstly and then changing a polarization of the initial light beam so as to form the incident light beam.

In one embodiment of the present disclosure, the uniaxial crystal element is one of a uni-axial crystal lens and a birefringent lens.

In one embodiment of the present disclosure, the uniaxial crystal element includes at least one uni-axial crystal lens, or includes at least one uni-axial crystal lens and a lens made of isotropic materials.

In one embodiment of the present disclosure, the uniaxial crystal element is produced from one of calcite, ruby, lithium niobate, quartz, rutile, zircon and liquid crystal.

As stated above, in the apparatus and method for cutting a multilayer material provided by the present disclosure, by passing the bi-polarized light beam through the uniaxial crystal element so as to have the bi-polarized light beam in correspondence to different refractive indexes and thereby to form two focuses with different focal lengths, thus advantages of layered focusing and one-process work can be obtained, varying widths of the heterogeneous area while in cutting the multilayer material can be lessened, and also cracking around the cut can be improved.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of an embodiment of the apparatus for cutting a multilayer material in accordance with the present disclosure;

FIG. 2 is a schematic illustration for a distribution of refractive index in the uniaxial crystal element of FIG. 1;

FIG. 3 is a schematic cross-sectional view of an embodiment of FIG. 2 at z=0;

FIG. 4 demonstrates schematically a work state of FIG. 1;

FIG. 5 is a schematic cross-sectional view of another embodiment of FIG. 2 at z=0;

FIG. 6 is a schematic view of another embodiment of the apparatus for cutting a multilayer material in accordance with the present disclosure;

FIG. 7 is a schematic view of a further embodiment of the apparatus for cutting a multilayer material in accordance with the present disclosure;

FIG. 8 shows schematically an exemplary example of the apparatus for cutting a multilayer material in accordance with the present disclosure;

FIG. 9 demonstrates schematically an embodiment of light transmission paths with respect to the splitter module of FIG. 8;

FIG. 10 shows schematically an exemplary example of the apparatus for cutting a multilayer material in accordance with the present disclosure;

FIG. 11 is a flowchart of the method for cutting a multilayer material internet accordance with the present disclosure; and

FIG. 12 is a detailed flowchart of Step S14 of FIG. 11.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

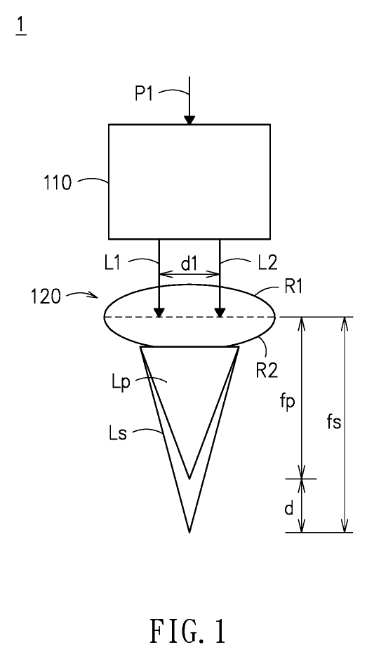

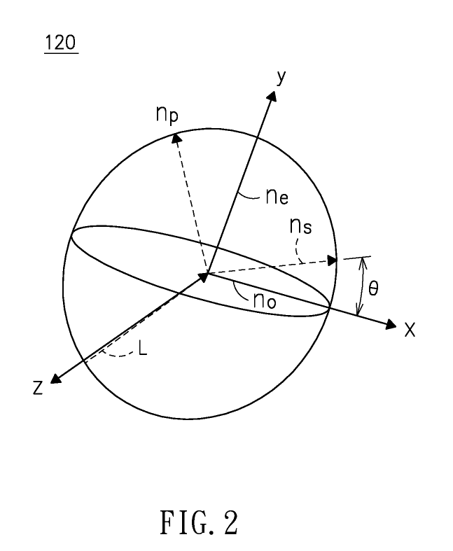

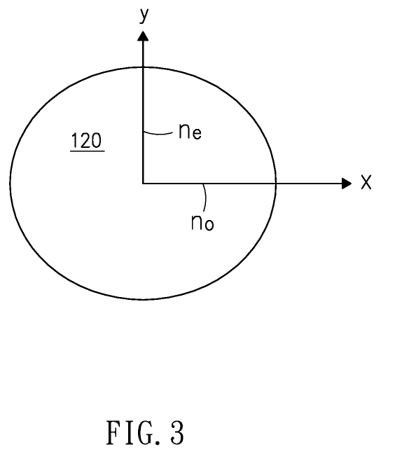

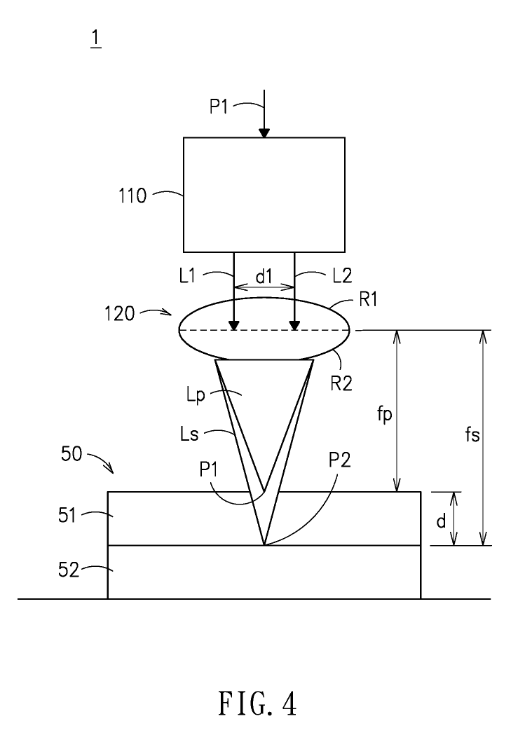

Refer now to FIG. 1 through FIG. 4; where FIG. 1 is a schematic view of an embodiment of the apparatus for cutting a multilayer material in accordance with the present disclosure, FIG. 2 is a schematic illustration for a distribution of refractive index in the uniaxial crystal element of FIG. 1, FIG. 3 is a schematic cross-sectional view of an embodiment of FIG. 2 at z=0, and FIG. 4 demonstrates schematically a work state of FIG. 1.

As shown in FIG. 1, in this embodiment, the apparatus for cutting a multilayer material 1 includes a splitter module 110 and a uniaxial crystal element 120.

The splitter module 110, located on a transmission path of an incident light beam P1, is applied to split the incident light beam P1 into a first polarized light beam L1 and a second polarized light beam L2. To explain conveniently, in FIG. 1 and FIG. 4, a spacing dl is exaggerated provided to separate the first polarized light beam L1 from the second polarized light beam L2. In practice, the spacing dl between the first polarized light beam L1 and second the polarized light beam L2 is adjustable. In one embodiment of the present disclosure, the spacing dl can be even adjusted to overlap the first polarized light beam L1 and the second polarized light beam L2. Namely, the first polarized light beam L1 and the second polarized light beam L2 can be adjusted to become coaxial light beams. In this embodiment, the splitter module 110 is a bi-polarized light generating device that can split the incident light beam P1 into two coaxial polarized light beams with perpendicular polarization directions. These two polarized lights can be defined as an s-polarized light beam (s-polarization) and a p-polarized light beam (p-polarization). In addition, this embodiment does not limit the light source of the incident light beam P1. The incident light beam P1 containing the s-polarized light and the p-polarized light can be a laser light beam or a polarized light beam generated by polarizing lights from a non-laser generating device (a pulse flashlight or a pulse LED, for example).

The uniaxial crystal element 120, located close to the splitter module 110, can be a uni-axial crystal lens or a birefringence lens. In this embodiment, the uniaxial crystal element 120 is consisted of at least one uni-axial crystal lens, or consisted of at least a uni-axial crystal lens and an isotropic lens. In material preparation, the uniaxial crystal element 120 is a convergent or divergent lens ground or machined from a uni-axial crystal material or a birefringence material. In this disclosure, the uni-axial crystal or birefringence material can be produced from calcite, ruby, lithium niobate, quartz, rutile, zircon, liquid crystal or the like material.

In this embodiment, the refractive index along one particular crystal axis of the uniaxial crystal element 120 (having three crystal axes) is different to those along the other two crystal axes. Such the particular axis is call as an abnormal axis, or an optical axis. As shown in FIG. 2 and FIG. 3, the light beam L propagates along the z axis, the refractive index along the y axis is nₑ, and the refractive indexes along the x axis and the z axis are both the identical nₒ. Hence, the y axis is selected to be the optical axis of the uniaxial crystal element 120, which is perpendicular to a normal line of the uniaxial crystal element 120. Also, □ is the angle between the light-polarizing direction and the x axis.

In details, equations for calculating the refractive indexes with respect to the first polarized light beam (p-polarized light beam) L1 and the second polarized light beam (s-polarized light beam) L2 are as follows. The refractive indexes nₚ and nₛ are derived by the following mathematical equations (1) and (2), respectively.

$$\begin{matrix}{n}_{s} = n ( θ ) = {( \frac{{n}_{0}^{2} {n}_{e}^{2}}{{n}_{e}^{2} {cos}^{2} θ + {n}_{0}^{2} {sin}^{2} θ} )}^{1 / 2} ; & ( 1 ) \\ {n}_{p} = n ( θ + 90 ° ) = {( \frac{{n}_{0}^{2} {n}_{e}^{2}}{{n}_{e}^{2} {sin}^{2} θ + {n}_{0}^{2} {cos}^{2} θ} )}^{1 / 2} . & ( 2 )\end{matrix}$$

In the art, the mathematical equation (3) for thin lens is expressed as follows.

$$\frac{1}{f} = ( n - 1 ) \times ( \frac{1}{R 1} - \frac{1}{R 2} ) . \qquad ( 3 )$$

In the mathematical equation (3), f stands for the thin-lens focal length, R1 stands for the curvature radius of lens' first surface, and R2 stands for the curvature radius of lens' second surface. By plugging the refractive indexes nₛ and nₚ derived from the mathematical equations (1) and (2) into the mathematical equation (3), then the focal lengths fp and fs with respect to the first polarized light beam L1 and the second polarized light beam L2, respectively, can be thus obtained. Thereby, the focus difference d can be obtained by (fs−fp). In this disclosure, algorithm for computing the focus difference is not limited to the aforesaid procedures. In some other embodiments not shown here, the focus difference d can be obtained directly by inputting the aforesaid parameters into commercial optical simulation software already available in the marketplace.

In one exemplary example having a quartz lens, by plugging the refractive indexes nₛ and nₚ of the quartz, 1.544 and 1.553 respectively, into the aforesaid mathematical equation (3), then the angle □ is 0° for the focus difference d of 2.992 mm, and 45° for the focus difference d of 0 mm (i.e., the refractive index nₛ is equal to the refractive index nₚ). Namely, the focus difference d can be adjusted by varying the angle □. In one embodiment of the present disclosure, a range of −15 mm˜15 mm for the focus difference d can be feasible by rotating the uniaxial crystal element 120. Thus, it is obvious that the uniaxial crystal element 12 of the present disclosure can be adopted as the transparent multilayer material for the opto-electronics and monitor industries.

In a demonstrative example of an optical simulation, for the bi-polarized light beam, the curvature radius of lens' first surface R1 of the uniaxial crystal element 120 (the quartz lens for example) that can generate the smallest focus (i.e. the least dispersion) is about 45.93 mm. At this instance, the dimension for the smallest focus is about 1.7 □m, the curvature radius R2 of lens' second surface is about 44.23 mm, and the smallest focus is sized to be about 0.171 □m. By applying the foregoing results of the optical simulation, the area of cracks can be substantially limited, and also formation of cracks around the cutting can be improved.

Referring now to FIG. 1, the uniaxial crystal element 120 is located on both the transmission paths of the first polarized light beam L1 and the second polarized light beam L2. Referring to FIG. 2, as the first polarized light beam L1 and the second polarized light beam L2 pass through the uniaxial crystal element 120, due to birefringence of the uniaxial crystal element 120, the first polarized light beam L1 would behave in correspondence to the refractive index nₚ, and the second polarized light beam L2 would behave in correspondence to the refractive index nₛ different to the refractive index nₚ, where the □ is the angle between the polarization direction of the second polarized light beam L2 and the x axis. Thereupon, the pulse focal lengths of the first polarized light beam L1 and the second polarized light beam L2 would be different so as to form respective focuses with different focal lengths.

In practical machining, as shown in FIG. 4, the multilayer material 50 includes a first layer structure 51 and a second layer structure 52. As described above, while the first polarized light beam L1 and the second polarized light beam L2 pass through the uniaxial crystal element 120, different refractive indexes would be referred to the first polarized light beam L1 and the second polarized light beam L2. Thereupon, the first polarized light beam L1 and the second polarized light beam L2 would have different pulse focal lengths so as to form two focuses with different focal lengths at the multilayer material 50. Referring to FIG. 4, after the first polarized light beam L1 passes through the uniaxial crystal element 120, a first beam range Lp would be formed, and a corresponding first focus P1 would be located on the surface of the first layer structure 51. Also, after the second polarized light beam L2 passes through the uniaxial crystal element 120, a second beam range Ls would be formed, and a corresponding second focus P2 would be located on the surface of the second layer structure 52. Since the pulse focal lengths of the first polarized light beam L1 and the second polarized light beam L2 are different, the first beam range Lp would be different to the second beam range Ls, and also the focal length of the first focus P1 would be different to that of the second focus P2. Namely, by providing this embodiment of the apparatus for cutting a multilayer material 1, the bi-polarized light beam would fulfill different refractive indexes, so that two focuses with different focal lengths would be targeted onto respective surfaces of two corresponding layers of the same multilayer material. Thereupon, the goal in layered focusing and one-process work can be thus obtained. Also, the phenomenon of irregular widths in the heterogeneous areas of the multilayer material during the cutting can be substantially improved, and cracks around the cut can be reduced.

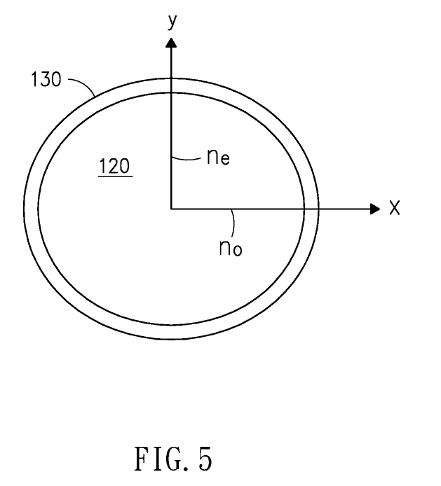

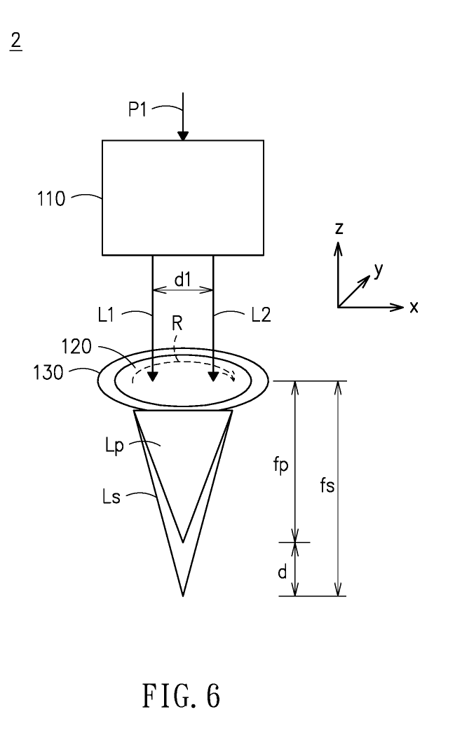

Refer now to FIG. 5 and FIG. 6; where FIG. 5 is a schematic cross-sectional view of another embodiment of FIG. 2 at z=0, and FIG. 6 is a schematic view of another embodiment of the apparatus for cutting a multilayer material in accordance with the present disclosure. It shall be noted that, for easy explanation, a spacing dl is presented exaggeratedly in FIG. 6 to separate clearly the first polarized light beam L1 from the second polarized light beam L2. However, it shall be understood that, in the present disclosure, the spacing dl between the first polarized light beam L1 and the second polarized light beam L2 are adjustable, even to a state of overlapping the first polarized light beam L1 and the second polarized light beam L2 (i.e., the first polarized light beam L1 and the second polarized light beam L2 are coaxial). In addition, the apparatus for cutting a multilayer material 2 of FIG. 6 and that 1 of FIG. 1 are structurally resembled to a pretty high degree. Thus, the same elements would be assigned by the same labels, and details thereabout would be omitted herein. Namely, in the following description, only differences in between will be elucidated.

The differences between the apparatus for cutting a multilayer material 2 of FIG. 6 and that 1 of FIG. 1 are described as follows. This embodiment of the apparatus for cutting a multilayer material 2 further includes a rotation element 130, and the uniaxial crystal element 120 is furnished to the rotation element 130. The rotation element 130 is introduced to rotate the uniaxial crystal element 120. The rotation axis of the rotation element 130 is align with the propagation direction of the incident light beam P1, or the rotation axis of the rotation element 130 forms and angle with the incident light beam P1. In this embodiment, the uniaxial crystal element 120 may be cut along the x axis and the y axis, and further ground into a corresponding lens to be fitted into the rotation element 130. In an exemplary example, the rotation element 130 can be a rotational platform. Obviously, by having the rotation element 130 to rotate the uniaxial crystal element 120, the uniaxial crystal element 120 can then adjust the focus difference d along a rotation direction R, such that focuses and the corresponding focus differences at individual layers of the multilayer material can be adjusted.

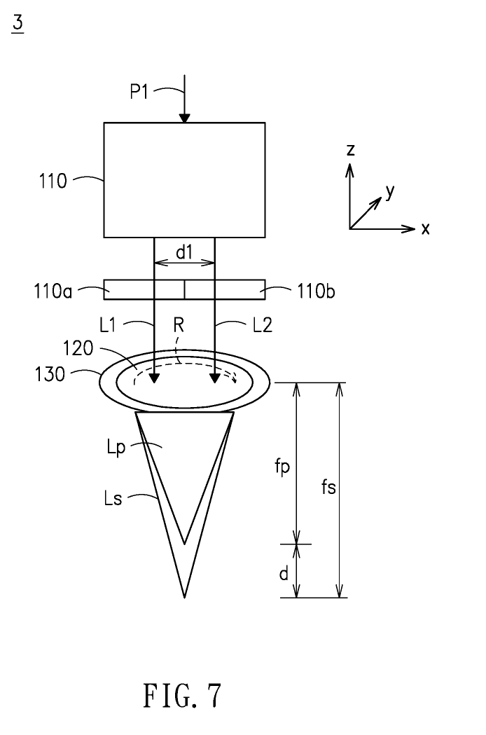

Referring now to FIG. 7, a schematic view of a further embodiment of the apparatus for cutting a multilayer material in accordance with the present disclosure is shown. It shall be noted that, for easy explanation, a spacing dl is presented exaggeratedly in FIG. 7 to separate clearly the first polarized light beam L1 from the second polarized light beam L2. However, it shall be understood that, in the present disclosure, the spacing dl between the first polarized light beam L1 and the second polarized light beam L2 are adjustable, even to a state of overlapping the first polarized light beam L1 and the second polarized light beam L2 (i.e., the first polarized light beam L1 and the second polarized light beam L2 are coaxial). In addition, the apparatus for cutting a multilayer material 3 of FIG. 7 and that 2 of FIG. 6 are structurally resembled to a pretty high degree. Thus, the same elements would be assigned by the same labels, and details thereabout would be omitted herein. Namely, in the following description, only differences in between will be elucidated.

The differences between the apparatus for cutting a multilayer material 3 of FIG. 7 and that 2 of FIG. 6 are described as follows. In this embodiment of the apparatus for cutting a multilayer material 3, the splitter module 110 includes a first attenuation element 110a and a second attenuation element 110b, located on the transmission paths of the polarized light beam L1 and the second polarized light beam L2, respectively. The first attenuation element 110a and the second attenuation element 110b are used to adjust corresponding light intensity of the first polarized light beam L1 and the second polarized light beam L2, respectively. For example, the light intensity of the first polarized light beam L1 can be enhanced, while the light intensity of the second polarized light beam L2 is attenuated. Similarly, the light intensity of the first polarized light beam L1 can be attenuated, while the light intensity of the second polarized light beam L2 is enhanced. In this embodiment, the light intensity, in percentage for example, can be varied from 100% to 0%, determined preferably up to the practical multilayer material.

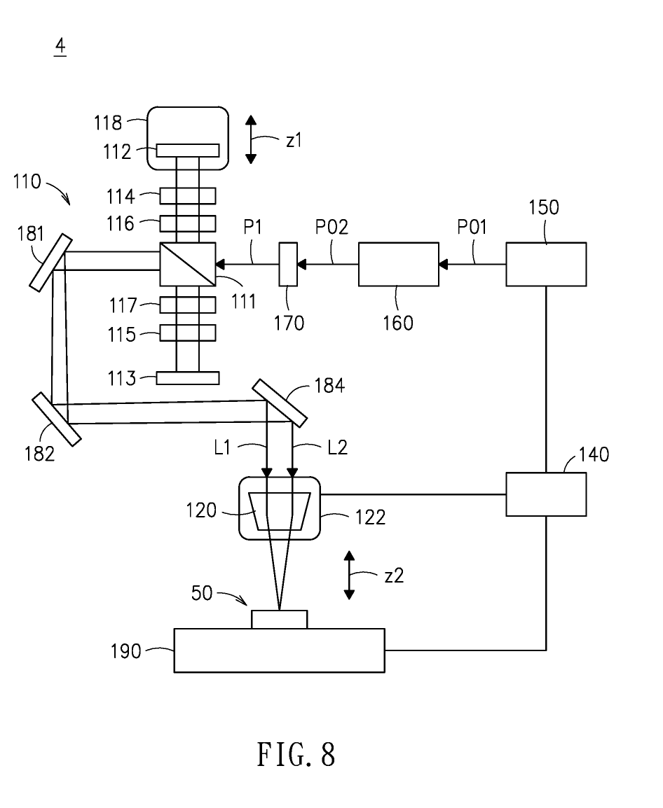

Referring now to FIG. 8, an exemplary example of the apparatus for cutting a multilayer material in accordance with the present disclosure is schematically shown. In this example, the apparatus for cutting a multilayer material 4 includes a splitter module 110, a uniaxial crystal element 120, a control element 140, a light source 150, a spatial filtering element 160, a wave plate 170, a first reflector 181, a second reflector 182, a third reflector 184 and a movement platform 190.

The control element 140, coupling the light source 150 and the uniaxial crystal element 120, performs a processor for handling cutting strategies for the apparatus for cutting a multilayer material 4. The control element 140 can be used to control the light-beam energy outputted from the light source 150, to adjust the rotation position and position of the uniaxial crystal element 120, and also to perform atmosphere control upon the air flow rate or the blowing direction.

The light source 150, connecting the aforesaid control element 140, is to generate an initial light beam P01, in which the initial light beam P01 is emitted directly by the light source 150. In this disclosure, the initial light beam P01 can be a laser light beam or a polarized light beam generated by polarizing lights from a non-laser generating device (a pulse flashlight or a pulse LED, for example).

In this embodiment, the spatial filtering element 160, disposed on the transmission path of the initial light beam P01 by closing to the light source 150, is to filter out the spatial noise in the initial light beam P01, or to pass therethrough lights with some predetermined spatial frequencies, so that a filtered light beam P02 can be formed after the initial light beam P01 passes through the spatial filtering element 160.

The wave plate 170, located on the transmission path of the filtered light beam P02, can be a half-wave plate or a quarter-wave plate. As the filtered light beam P02 passes through the wave plate 170, the filtered light beam P02 would be polarized to form the incident light beam P1. Thereupon, the incident light beam P1 can thus contain the s-polarized light and the p-polarized light. It shall be noted that, in an embodiment not shown here, the wave plate 170 may be disposed on the transmission path of the initial light beam P01, so that the initial light beam P01 generated by the light source 150 can be sent directly through the wave plate 170 to polarize the initial light beam P01 and then to have the incident light beam P1 to contain the s-polarized light and the p-polarized light. Namely, the wave plate 170 as an option on the optical transmission path can be selected according to practical requirements.

The splitter module 110 includes a polarizing beam splitter 111, a first reflection element 112, a second reflection element 113, a first attenuation element 114, a second attenuation element 115, a first wave plate 116, a second wave plate 117 and a displacement element 118.

The polarizing beam splitter (PBS) 111, located on the transmission path of the incident light beam P1, is to split the incident light beam P1 into two polarized light beams perpendicular to each other, a first polarized light beam and a second polarized light beam. The first polarized light beam (i.e., the p-polarized light beam) L1 passes the polarizing beam splitter 111 completely, while the second polarized light beam (i.e., the s-polarized light beam) L2 is reflected by 45° so as to form a 90° angle with the first polarized light beam. In addition, the wave plate 170, located in front of the polarizing beam splitter 111 in a light-transmission view, is to adjust light-intensity percentages of the first polarized light beam L1 and the second polarized light beam L2; for example, to enhance the light-intensity percentage of the first polarized light beam L1 while reducing the light intensity percentage of the second polarized light beam L2, or to enhance the light-intensity percentage of the second polarized light beam L2 while reducing the light intensity percentage of the first polarized light beam L1. Generally, the light-intensity percentage varies from 100% to 0%, depending on the choice of the multilayer material.

The first reflection element 112 and the second reflection element 113 are located to opposing sides of the polarizing beam splitter 111. Between the first reflection element 112 and the polarizing beam splitter 111, the first attenuation element 114 and the first wave plate 116 are located, with the first attenuation element 114 to be positioned between the first reflection element 112 and the first wave plate 116, and the first wave plate 116 to be positioned between the first attenuation element 114 and the polarizing beam splitter 111. On the other hand, the second wave plate 117 and the second attenuation element 115 are located between the second reflection element 113 and the polarizing beam splitter 111, with the second attenuation element 115 to be positioned between the second reflection element 113 and the second wave plate 117, and the second wave plate 117 to be positioned between the polarizing beam splitter 111 and the second attenuation element 115. Each of the first wave plate 116 and the second wave plate 117 can be a half-wave plate or a quarter-wave plate.

Both the first reflection element 112 and the second reflection element 113 can change the polarization of light, in which the first reflection element 112 can displace with respect to the polarizing beam splitter 111, while the second reflection element 113 can displace with respect to the polarizing beam splitter 111; such that the optical path difference between the first polarized light beam L1 and the second polarized light beam L2 can be varied. As shown in FIG. 8, the first reflection element 112 is mounted with the displacement element 118 capable of displacing in a z1 direction, and thus the first reflection element 112 can displace with respect to the polarizing beam splitter 111 in the z1 direction. In another embodiment not shown here, the second reflection element 113 can be also mounted with another displacement element so as allow the second reflection element 113 to displace with respect to the polarizing beam splitter 111.

The first attenuation element 114 and the second attenuation element 115 are located on the transmission paths of the first polarized light beam L1 and the second polarized light beam L2, respectively. The first attenuation element 114 and the second attenuation element 115 are used to adjust the corresponding light-intensity percentages of the first polarized light beam L1 and the second polarized light beam L2, respectively; for example, to enhance the light-intensity percentage of the first polarized light beam L1 while reducing the light intensity percentage of the second polarized light beam L2, or to enhance the light-intensity percentage of the second polarized light beam L2 while reducing the light intensity percentage of the first polarized light beam L1. Generally, the light-intensity percentage varies from 100% to 0%, depending on the choice of the multilayer material.

By providing the aforesaid splitter module 110, after the incident light beam P1 passes through the splitter module 110, the splitter module 110 would split the incident light beam P1 into a first polarized light beam L1 and a second polarized light beam L2 coaxial with the first polarized light beam L1. For a concise explanation, the first polarized light beam L1 and the second polarized light beam L2 of FIG. 8 are strictly separated from each other. However, it shall be understood that, practically, the spacing between the first polarized light beam L1 and the second polarized light beam L2 is adjustable. In one embodiment of the present disclosure, the spacing between the first polarized light beam L1 and the second polarized light beam L2 are completely adjusted to vanish so as to overlap the first polarized light beam L1 onto the second polarized light beam L2.

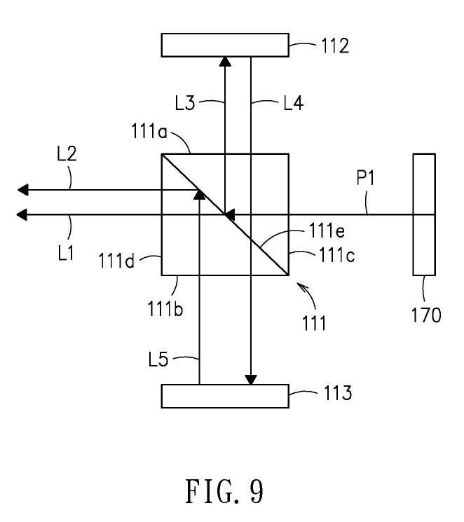

In details, referring now to FIG. 9, an embodiment of light transmission paths with respect to the splitter module of FIG. 8 is demonstrated schematically. As noted in FIG. 9, for a concise explanation, the embodiment thereof has omitted the exhibition of a first attenuation element 114, a second attenuation element 115, a first wave plate 116, a second wave plate 117 and a displacement element 118. (Please refer to FIG. 8 and the corresponding descriptions for details of theses omitted elements.)

In this embodiment, the polarizing beam splitter 111, consisted of two prisms, includes a first plane 111a, a second plane 111b, an incident plane 111c, an emergent plane 111d and a splitting interface 111e.

As shown, the polarizing beam splitter 111 is located between the first reflection element 112 and the second reflection element 113 by opposing the first plane 111a to the second plane 111b, facing the first plane 111a to the first reflection element 112, and facing the second plane 111b to the second reflection element 113. Namely, the first reflection element 112 and the second reflection element 113 are located to two opposing sides of the polarizing beam splitter 111.

In addition, the incident plane 111c is located oppositely with respect to the emergent plane 111d. The polarizing beam splitter 111 is located on the transmission path of the incident light beam P1, so that the incident light beam P1 can enter the polarizing beam splitter 111 by penetrating directly through the incident plane 111c, and is then led to the splitting interface 111e.

The splitting interface 111e splits the incident light beam P1 into two orthogonal polarized light beams, i.e., the p-polarized light beam and the s-polarized light beam. The p-polarized light beam of the incident light beam P1 penetrates through the splitting interface 111e, then leaves the polarizing beam splitter 111 by penetrating through the emergent plane 111d, and is defined as the first polarized light beam L1 thereafter. On the other hand, the s-polarized light beam of the incident light beam P1 is reflected to go upward by the splitting interface 111e, and then penetrate through the first plane 111a to become a third polarized light beam L3. The polarization direction of the third polarized light beam L3 is perpendicular to that of the first polarized light beam L1, in which the third polarized light beam L3 is an s-polarized light.

Then, the third polarized light beam L3, reflected by the splitting interface 111e and penetrating through the first plane 111a, reaches the first reflection element 112. The first reflection element 112 turns the third polarized light beam L3 into a fourth polarized light beam L4 to travel in a reverse direction with respect to the third polarized light beam L3. The fourth polarized light beam L4 penetrates through the first plane 111a, and then penetrates directly also through the splitting interface 111e. The polarization direction of the fourth polarized light beam L4 is perpendicular to that of the third polarized light beam L3, in which the fourth polarized light beam L4 is a p-polarized light.

Then, the fourth polarized light beam L4 through the splitting interface 111e travels forward to leave the polarizing beam splitter 111 by penetrating through the second plane 111b. The fourth polarized light beam L4 then reaches the second reflection element 113 and is turned to become a fifth polarized light beam L5 by the second reflection element 113 to travel in a reverse direction with respect to the fourth polarized light beam L4. The polarization direction of the fifth polarized light beam L5 is perpendicular to that of the fourth polarized light beam L4, in which the fifth polarized light beam L5 is an s-polarized light. The fifth polarized light beam L5 enters the polarizing beam splitter 111, and then is reflected by the splitting interface 111e to leave the polarizing beam splitter 111 by penetrating through the emergent plane 111d. Then, the fifth polarized light beam L5 after leaving the polarizing beam splitter 111 is then defined as the second polarized light beam L2.

Upon the aforesaid arrangement of the optical paths related to the splitter module 110 of FIG. 9, the incident light beam P1 can then be split into the first polarized light beam L1 and the second polarized light beam L2. For a concise explanation, the first polarized light beam L1 and the second polarized light beam L2 of FIG. 9 are strictly separated from each other. However, it shall be understood that, practically, the spacing between the first polarized light beam L1 and the second polarized light beam L2 is adjustable. In one embodiment of the present disclosure, the spacing between the first polarized light beam L1 and the second polarized light beam L2 are completely adjusted to vanish so as to overlap the first polarized light beam L1 onto the second polarized light beam L2. As shown in FIG. 8, upon the reflection arrangement of the transmission paths by associating the first reflector 181, the second reflector 182 and the third reflector 184, the first polarized light beam L1 and the second polarized light beam L2 can be introduced to the uniaxial crystal element 120. By having the first polarized light beam L1 and the second polarized light beam L2 to penetrate through the uniaxial crystal element 120, since the first polarized light beam L1 and the second polarized light beam L2 are corresponding to different refractive indexes in the uniaxial crystal element 120, thus the first polarized light beam L1 and the second polarized light beam L2 would form different pulse focal lengths and two different focuses, with individual focal lengths, at the multilayer material 50.

In addition, referring back to FIG. 8, the uniaxial crystal element 120 can connect with an adjustment platform 122 to obtain an ability of displacing in a z2 direction with the adjustment platform 122. Namely, by providing the adjustment platform 122 to connect the uniaxial crystal element 120, the uniaxial crystal element 120 can thus displace with respect to the multilayer material 50, such that the positions of the two focuses (the first focus and the second focus) can be varied. In addition, the multilayer material 50 can be positioned on the movement platform 190 coupled electrically with the control element 140, such that the control element 140 can control the displacement of the movement platform 190. Namely, positioning of the multilayer material 50 with respect to the uniaxial crystal element 120 can be controlled by the control element 140.

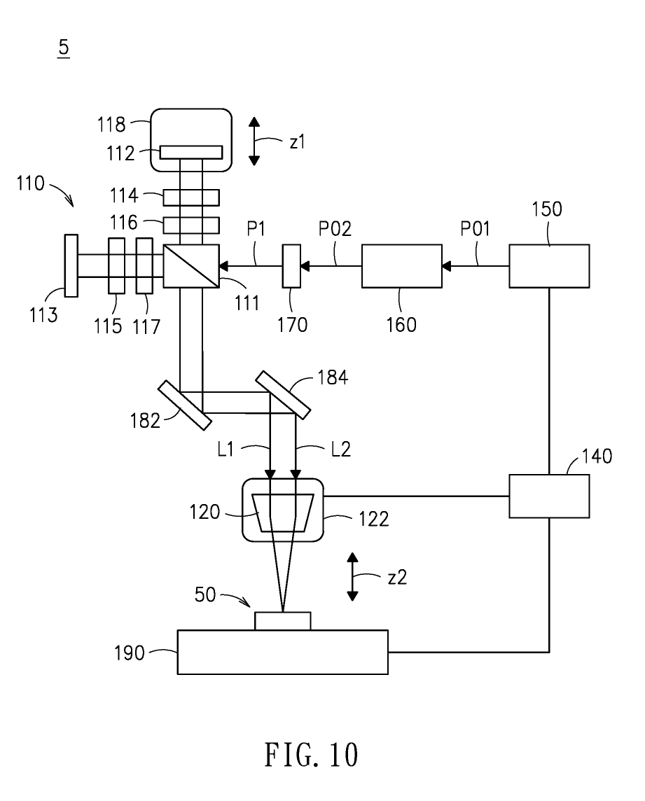

Nevertheless, this disclosure provides no specific limitations on the design or arrangement of the optical paths (i.e., the transmission paths) related to the splitter module. As long as any optical path arrangement that can provide bi-polarized light beams, then this arrangement of the optical paths can be a candidate for the present disclosure. Referring now to FIG. 10, an exemplary example of the apparatus for cutting a multilayer material in accordance with the present disclosure is schematically shown. For a concise explanation, the first polarized light beam L1 and the second polarized light beam L2 of FIG. 10 are strictly separated from each other. However, it shall be understood that, practically, the spacing between the first polarized light beam L1 and the second polarized light beam L2 is adjustable. In one embodiment of the present disclosure, the spacing between the first polarized light beam L1 and the second polarized light beam L2 are completely adjusted to vanish so as to overlap the first polarized light beam L1 onto the second polarized light beam L2. In addition, the apparatus for cutting a multilayer material 5 of FIG. 10 and that 4 of FIG. 8 are structurally resembled to a pretty high degree. Thus, the same elements would be assigned by the same labels, and details thereabout would be omitted herein. Namely, in the following description, only differences in between will be elucidated.

The differences between the apparatus for cutting a multilayer material 5 of FIG. 10 and that 4 of FIG. 8 are described as follows. In this embodiment of the apparatus for cutting a multilayer material 5 of FIG. 10, positioning of the second reflection element 113, the second attenuation element 115 and the second wave plate 117 are different to the corresponding positioning of the second reflection element 113, the second attenuation element 115 and the second wave plate 117 of FIG. 8. As shown in FIG. 10, the second reflection element 113, the second attenuation element 115 and the second wave plate 117 are located aside to the first reflection element 112, the first attenuation element 114, the first wave plate 116 and the displacement element 118, respectively. In FIG. 8, the second reflection element 113, the second attenuation element 115 and the second wave plate 117 are located by opposing to the first reflection element 112, the first attenuation element 114, the first wave plate 116 and the displacement element 118, respectively, with respect to the polarizing beam splitter 111.

In addition, since the positions of the second reflection element 113, the second attenuation element 115 and the second wave plate 117 are varied, so this embodiment of the apparatus for cutting a multilayer material 5 requires only the second reflector 182 and the third reflector 184 to forward the first polarized light beam L1 and the second polarized light beam L2 into the uniaxial crystal element 120, respectively.

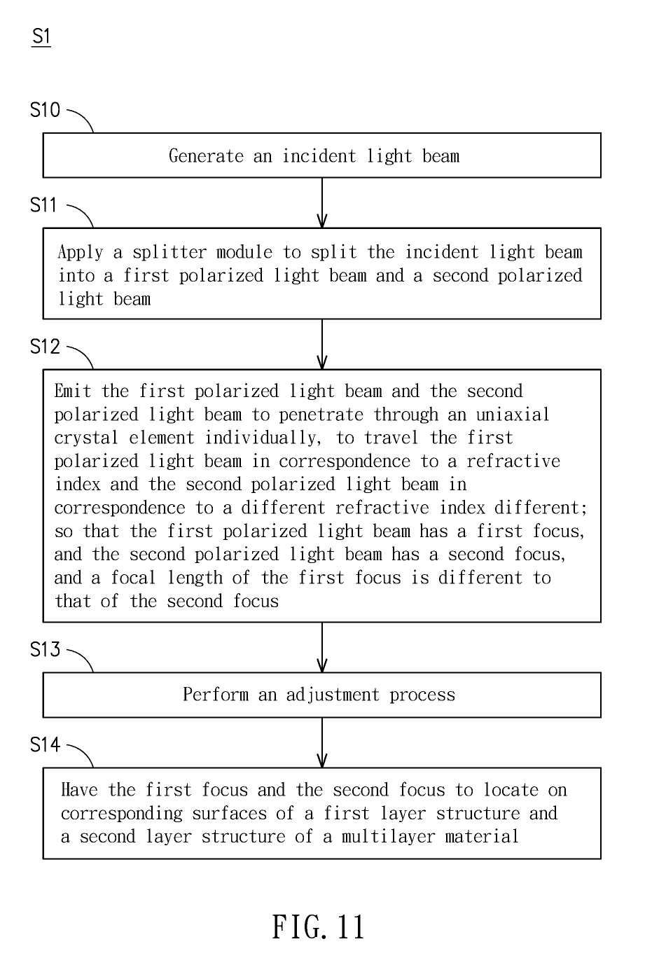

Referring now to FIG. 11, a flowchart of the method for cutting a multilayer material internet accordance with the present disclosure is shown. In this embodiment, the method for cutting a multilayer material Si includes Steps S10˜S14 as follows.

Firstly, Step S10 is performed to generate an incident light beam P1. The generation of the incident light beam P1 includes further the following procedures. Firstly, an initial light beam P01 is generated, in which the initial light beam P01 can be a laser light beam or a polarized light beam generated by polarizing lights from a non-laser generating device (a pulse flashlight or a pulse LED, for example). Then, the polarization of the initial light beam P01 is varied to form a corresponding incident light beam. For example, a wave plate can be adopted to vary the polarization of the initial light beam so as to contain an s-polarized light and a p-polarized light.

Then, Step S11 is performed to apply a splitter module 110 to split the incident light beam P1 into a first polarized light beam L1 and a second polarized light beam L2. The arrangement of the optical paths related to the splitter module 110 can adopt, but not limit to, that of FIG. 8 or FIG. 10. In addition, the spacing between the first polarized light beam L1 and the second polarized light beam L2 are adjustable. In one embodiment of the present disclosure, the first polarized light beam L1 and the second polarized light beam L2 are strictly separated from each other. However, it shall be understood that, practically, the spacing between the first polarized light beam L1 and the second polarized light beam L2 is adjustable. In one embodiment of the present disclosure, the spacing between the first polarized light beam L1 and the second polarized light beam L2 are completely adjusted to vanish so as to overlap the first polarized light beam L1 onto the second polarized light beam L2.

Then, Step S12 is performed to emit the first polarized light beam L1 and the second polarized light beam L2 to penetrate through an uniaxial crystal element 120 individually, so as to travel the first polarized light beam L1 in correspondence to a refractive index nₚ, and to travel the second polarized light beam L2 in correspondence to another refractive index nₛ different to the refractive index nₚ. Further, the first polarized light beam L1 would form a first focus P1, while the second polarized light beam L2 forms a second focus P2. The focal length corresponding to the first focus P1 is different to that corresponding to the second focus P2. Hence, since the uniaxial crystal element 120 is birefringent, thus the first polarized light beam L1 and the second polarized light beam L2 would travel in correspondence to different refractive indexes, and thereby to form two focuses associated with different focal lengths.

Then, Step S13 is performed, as an adjustment process.

In one embodiment of the present disclosure, the adjustment process is to rotate the uniaxial crystal element 120 so as thereby to adjust the focus difference d. For example, a rotational platform can be used to rotate the uniaxial crystal element 120 so as to adjust the focus difference d within −15 mm˜15 mm. Hence, such a technique can be applied to various transparent multilayer materials used in the optoelectronics and display industries, and can provide a resort to determine positions of focuses and respective focus differences for different layers of the multilayer material to be machined.

In one embodiment of the present disclosure, the adjustment process can be performed by displacing the uniaxial crystal element 120 to adjust positions of the first and second focuses P1 and P2. For example, the adjustment platform 122 can be driven to displace the uniaxial crystal element 120 with respect to the multilayer material 50, such that the positions of the first and second focuses P1 and P2 can be adjusted.

In one embodiment of the present disclosure, the adjustment process can be performed by adjusting light-intensity percentages of the first polarized light beam L1 and the second polarized light beam L2. For example, the wave plate 170 can be adjusted to vary the light-intensity percentages of the first polarized light beam L1 and the second polarized light beam L2, or the first attenuation element 114 and the second attenuation element 115 can be adjusted individually to vary the light-intensity percentages of the first polarized light beam L1 and the second polarized light beam L2, respectively; for instance, to enhance the light-intensity percentage of the first polarized light beam L1 while reducing the light intensity percentage of the second polarized light beam L2, or to enhance the light-intensity percentage of the second polarized light beam L2 while reducing the light intensity percentage of the first polarized light beam L1. Generally, the light-intensity percentage varies from 100% to 0%, depending on the choice of the multilayer material.

In one embodiment of the present disclosure, the adjustment process is performed by varying optical path differences of the first polarized light beam L1 and the second polarized light beam L2. For example, the first reflection element 112 and/or the second reflection element 113 can be displaced individually with respect to the polarizing beam splitter 111, such that the optical path differences of the first polarized light beam L1 and the second polarized light beam L2 can be varied accordingly.

Then, Step S14 is performed to have the first focus P1 and the second focus P2 to land, respectively, on a surface of a first layer structure 51 and another surface of a second layer structure 52 of a multilayer material 50. Thereby, by performing the aforesaid Step S10 through Step S14 of this embodiment, the bi-polarized light beam can be used to form different polarized light beams for contributing respective focal lengths, such that desired concentrated stressing points (i.e., the focuses) can be located individually to predetermined layers for machining. Thereupon, advantages of layered focusing and one-process work can be obtained, varying widths of the heterogeneous area while in cutting the multilayer material can be lessened, and also cracking around the cut can be improved.

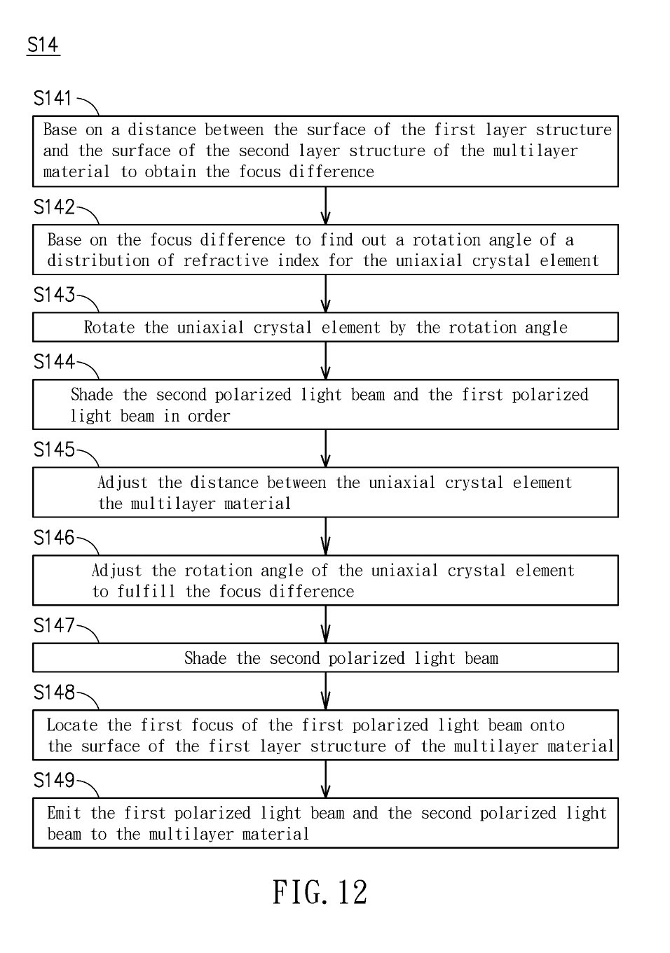

Referring now to FIG. 12, a detailed flowchart of Step S14 of FIG. 11 is shown. As described above, Step S14 is a step to have the first focus P1 and the second focus P2 to land, respectively, on the surface of the first layer structure 51 and another surface of the second layer structure 52 of the multilayer material 50. In this embodiment, Step S14 can further include Step S141 to Step S149 as follows.

Firstly, in Step S141, the focus difference d is obtained by evaluating a distance between the surface of the first layer structure 51 and the another surface of the second layer structure 52 of the multilayer material 50.

Then, in Step S142, based on the focus difference d to determine a rotation angle for the distribution of refractive index of the uniaxial crystal element 120. In one embodiment of the present disclosure, obtain the thickness of the multilayer material (i.e., the focus difference d of FIG. 4) from laboratory data or the manufacturer firstly, and then rotate the uniaxial crystal element (referred to FIG. 2) till a rotation angle fulfilling the focus difference d of Step S141 is found.

Then, in Step S143, rotate the uniaxial crystal element 120 by the rotation angle.

In Step S144, shade the second polarized light beam L2 and the first polarized light beam L1 in order. Then, in Step S145, adjust the distance between the uniaxial crystal element 120 and the multilayer material 50 so as to find out orderly the position of the first focus P1 of the first polarized light beam L1 on the surface of the first layer structure 51 of the multilayer material 50 and the position of the second focus P2 of the second polarized light beam L2 on the surface of the second layer structure 52 of the multilayer material 50.

In one exemplary example, the p-polarized light beam in the splitter module 110 is firstly shaded. Then, the distance between the uniaxial crystal element 120 and the multilayer material 50 is adjusted. Apply a coaxial vision test or a laser line test to place the first focus P1 of the first polarized light beam L1 onto the surface of the first layer structure 51 of the multilayer material 50. The coaxial vision test can introduce a CCD (Charge-coupled device) image-capturing apparatus to capture the configuration of the focus point on the surface of the first layer structure 51 of the multilayer material 50. Then, adjust the distance between the uniaxial crystal element 120 and the multilayer material 50 to have the smallest light spot, which is defined as the first focus P1. Upon obtaining the first focus P1, record the first distance as the distance between the uniaxial crystal element 120 and the surface of the first layer structure 51 of the multilayer material 50. On the other hand, while in applying the laser line test, execute one laser scan on the surface of the first layer structure 51 of the multilayer material 50 at each adjustment of the distance between the uniaxial crystal element 120 and the multilayer material 50. Observe the scan line on the surface at each scan. Among all these scan-line observations, choose the scan that provides the smallest width of the scan line. Upon the scan having the narrowest scan line, the position of the first focus P1 as well as the first distance is determined. Then, the s-polarized light beam in the splitter module 110 is shaded. Apply the coaxial vision test or the laser line test to focus the second polarized light beam L2 onto the surface of the second layer structure 52 of the multilayer material 50, so that the position of the second focus P2 of the second polarized light beam L2 on the surface of the second layer structure 52 of the multilayer material 50 can be determined. Upon obtaining the second focus P3, record the second distance as the distance between the uniaxial crystal element 120 and the surface of the second layer structure 52 of the multilayer material 50.

Then, in Step S146, rotate the uniaxial crystal element 120 to fulfill the focus difference d. Through Step S144 to Step S145, after the first distance and the second distance are found, the difference between the first distance and the second distance is defined as the focus difference d. Then, rotate the uniaxial crystal element 120 to find out a rotation angle that fulfills the focus difference d.

Then, in Step S147, the second polarized light beam L2 is shaded. After the shading, Step S148 is performed to focus the first polarized light beam L1 on the surface of the first layer structure 51 of the multilayer material 50 so as to locate the position of the first focus P1 thereon. Then, in Step S149, have both the first polarized light beam L1 and the second polarized light beam L2 to project onto the multilayer material 50. Further, the light intensity percentages of the first polarized light beam L1 and the second polarized light beam L2 are determined by testing the cutting process.

In summary, by providing the apparatus and method for cutting a multilayer material in accordance with the present disclosure, the bi-polarized light beam is used to pass through the uniaxial crystal element to form two different polarized light beams in correspondence to different refractive indexes, so that two focuses with different focal lengths can be positioned onto two different layer surfaces in the multilayer material, and such that desired concentrated stressing points (i.e., the focuses) can be located individually to predetermined layers for machining. Thereupon, advantages of layered focusing and one-process work can be obtained, varying widths of the heterogeneous area while in cutting the multilayer material can be lessened, and also cracking around the cut can be improved.

Further, by turning the uniaxial crystal element of this disclosure, the focus difference can thus be adjusted to relocate the focuses onto expected layers of the multilayer material, such that preferred machining parameters to meet different materials in individual layers can thus be applied.

In addition, according to the present disclosure, the light-intensity percentages of the bi-polarized light beams can be adjusted to better fit the cutting requirements upon different layers of the multilayer material.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An apparatus for cutting a multilayer material, comprising:
a splitter module, located on a transmission path of an incident light beam, being to split the incident light beam into a first polarized light beam and a second polarized light beam; and
a uniaxial crystal element, located close to the splitter module, having an optical axis perpendicular to a normal line of the uniaxial crystal element; wherein the uniaxial crystal element is located on both transmission paths of the first polarized light beam and the second polarized light beam, the first polarized light beam and the second polarized light beam pass through the uniaxial crystal element individually by having the first polarized light beam corresponding to a first refractive index and the second polarized light beam corresponding to a second refractive index different to the first refractive index, thus the first polarized light beam has a first focus, the second polarized light beam has a second focus, and a focal length of the first focus is different to that of the second focus.

2. The apparatus for cutting a multilayer material of claim 1, further including a rotation element, the uniaxial crystal element being mounted at the rotation element, a focus difference being formed between the first focus and the second focus, the rotation element being to rotate the uniaxial crystal element so as to adjust the focus difference, the rotation element having a rotation axis, the rotation axis being located on the transmission path of the incident light beam or forming an angle with the incident light beam.

3. The apparatus for cutting a multilayer material of claim 2, wherein the focus difference is within −15 mm˜15 mm.

4. The apparatus for cutting a multilayer material of claim 1, wherein the first polarized light beam and the second polarized light beam are coaxial or separated by a spacing.

5. The apparatus for cutting a multilayer material of claim 4, wherein the spacing between the first polarized light beam and the second polarized light beam is an adjustable spacing.

6. The apparatus for cutting a multilayer material of claim 1, further including an adjustment platform connected with the uniaxial crystal element, the adjustment platform being to displace the uniaxial crystal element so as to adjust positions of the first focus and the second focus.

7. The apparatus for cutting a multilayer material of claim 1, wherein the uniaxial crystal element is one of a uni-axial crystal lens and a birefringent lens.

8. The apparatus for cutting a multilayer material of claim 1, wherein the uniaxial crystal element includes at least one uni-axial crystal lens, or at least one uni-axial crystal lens and a lens made of isotropic materials.

9. The apparatus for cutting a multilayer material of claim 1, wherein the splitter module includes a polarizing beam splitter located on the transmission path of the incident light beam for splitting the incident light beam into the first polarized light beam and the second polarized light beam.

10. The apparatus for cutting a multilayer material of claim 9, wherein the splitter module includes a wave plate located in front of the polarizing beam splitter for adjusting light-intensity percentages of the first polarized light beam and the second polarized light beam.

11. The apparatus for cutting a multilayer material of claim 10, wherein the wave plate is one of a half-wave plate and a quarter-wave plate.

12. The apparatus for cutting a multilayer material of claim 9, wherein the splitter module includes a first attenuation element and a second attenuation element, both located on the corresponding transmission paths of the first polarized light beam and the second polarized light beam, respectively, the first attenuation element and the second attenuation element being to adjust light-intensity percentages of the first polarized light beam and the second polarized light beam.

13. The apparatus for cutting a multilayer material of claim 12, wherein the splitter module includes a first reflection element and a second reflection element, located oppositely to each other and aside to the polarizing beam splitter, the first attenuation element being positioned between the first reflection element and the polarizing beam splitter, the second attenuation element being positioned between the second reflection element and the polarizing beam splitter.

14. The apparatus for cutting a multilayer material of claim 13, wherein the first reflection element has an ability to displace with respect to the polarizing beam splitter.

15. The apparatus for cutting a multilayer material of claim 13, wherein the second reflection element has an ability to displace with respect to the polarizing beam splitter.

16. The apparatus for cutting a multilayer material of claim 9, wherein the splitter module includes a first wave plate and a second wave plate, located individually aside to the polarizing beam splitter.

17. The apparatus for cutting a multilayer material of claim 16, wherein each of the first wave plate and the second wave plate is one of a half-wave plate and a quarter-wave plate.

18. The apparatus for cutting a multilayer material of claim 10, further including a light source for generating an initial light beam, wherein the wave plate located on a transmission path of the initial light beam is to change a polarization of the initial light beam so as to form the incident light beam.

19. The apparatus for cutting a multilayer material of claim 18, further including a control element connected with the light source and the uniaxial crystal element.

20. The apparatus for cutting a multilayer material of claim 18, further including a spatial filtering element located aside to the light source and on the transmission path of the initial light beam.

21. A method for cutting a multilayer material, comprising the steps of:
(1) a splitter module splitting an incident light beam into a first polarized light beam and a second polarized light beam;
(2) the first polarized light beam and the second polarized light beam passing through an uniaxial crystal element individually by having the first polarized light beam corresponding to a first refractive index and the second polarized light beam corresponding to a second refractive index different to the first refractive index; so that the first polarized light beam has a first focus, and the second polarized light beam has a second focus; a focal length of the first focus being different to that of the second focus, a focus difference existing between the first focus and the second focus; and
(3) the first focus and the second focus being located individually on a surface of a first layer structure and another surface of a second layer structure of a multilayer material, respectively.

22. The method for cutting a multilayer material of claim 21, after the step (2), further including an adjustment process.

23. The method for cutting a multilayer material of claim 22, wherein the adjustment process includes a step of rotating the uniaxial crystal element to adjust the focus difference.

24. The method for cutting a multilayer material of claim 22, wherein the adjustment process includes a step of displacing the uniaxial crystal element to adjust positions of the first focus and the second focus.

25. The method for cutting a multilayer material of claim 22, wherein the adjustment process includes a step of adjusting individually light-intensity percentages of the first polarized light beam and the second polarized light beam.

26. The method for cutting a multilayer material of claim 22, wherein the adjustment process includes a step of varying an optical path difference of the first polarized light beam and the second polarized light beam.

27. The method for cutting a multilayer material of claim 21, wherein the step (3) further includes the step of:
(31) basing on a distance between the surface of the first layer structure and the another surface of the second layer structure of the multilayer material to obtain the focus difference;
(32) basing on the focus difference to find out a rotation angle of a distribution of refractive index for the uniaxial crystal element;
(33) rotating the uniaxial crystal element by the rotation angle;
(34) shading orderly the second polarized light beam and the first polarized light beam;
(35) adjusting a distance between the uniaxial crystal element and the multilayer material so as to find out orderly a position of the first focus of the first polarized light beam on the surface of the first layer structure of the multilayer material and another position of the second focus of the second polarized light beam on the another surface of the second layer structure of the multilayer material;
(36) adjusting the rotation angle of the uniaxial crystal element to fulfill the focus difference;
(37) shading the second polarized light beam;
(38) locating the first focus of the first polarized light beam onto the surface of the first layer structure of the multilayer material; and
(39) emitting the first polarized light beam and the second polarized light beam to the multilayer material.

28. The method for cutting a multilayer material of claim 27, wherein the step (35) includes a sub-step of applying one of a coaxial vision test and a laser line test to locate the first focus of the first polarized light beam and the second focus of the second polarized light beam onto the corresponding surfaces of the first layer structure and the second layer structure of the multilayer material.

29. The method for cutting a multilayer material of claim 21, further including a step of generating the incident light beam by generating an initial light beam firstly and then changing a polarization of the initial light beam so as to form the incident light beam.

30. The method for cutting a multilayer material of claim 21, wherein the uniaxial crystal element is one of a uni-axial crystal lens and a birefringent lens.

31. The method for cutting a multilayer material of claim 21, wherein the uniaxial crystal element includes at least one uni-axial crystal lens, or includes at least one uni-axial crystal lens and a lens made of isotropic materials.

32. The method for cutting a multilayer material of claim 21, wherein the uniaxial crystal element is produced from one of calcite, ruby, lithium niobate, quartz, rutile, zircon and liquid crystal.
